(19) United States
(12) Patent Application Publication
(10) Pub. No.: US 2026/0322739 A1
(43) Pub. Date: Oct. 15, 2026

(54) AUTOMATED GATEWAY IDENTIFICATION USING KNOWN COMPUTING ELEMENT AT A LOCATION

(71) Applicant: Tailscale Inc., Toronto (CA)

(72) Inventor: Bradley J. Fitzpatrick, Seattle, WA (US)

(21) Appl. No.: 19/467,208

(22) Filed: Feb. 2, 2026

Related U.S. Application Data
(60) Provisional application No. 63/752,246, filed on Jan. 31, 2025.

(51) Int. Cl. H04L 45/741; H04L 12/46; H04L 12/66; H04L 45/745; H04L 61/58

(52) U.S. Cl. CPC H04L 45/741; H04L 12/4633; H04L 12/66; H04L 45/745; H04L 61/58

(57) ABSTRACT

The technology disclosed herein enables network gateway identification using a computing element known to be located behind the gateway. In an example, a system includes a coordination service configured to maintain associations between computing elements and gateways including gateway identifiers and corresponding public network addresses and provide, responsive to requests, gateway information usable to form destination IPv6 addresses that encode IPv4 addresses and gateway identifiers. The system also includes a source computing element configured to receive a destination identifier and a collocated identifier, request gateway information from the coordination service, form a packet with a destination IPv6 address encoding a destination IPv4 address and a gateway identifier, and send an encapsulated version of the packet over an IPv6 network. The system further includes one or more gateways configured to extract the packet from the encapsulated packet; and forward the packet to the destination IPv4 address over an IPv4 network.

### RELATED APPLICATION

This application is related to and claims priority to U.S. Provisional Patent Application 63/752,246, titled “AUTOMATED GATEWAY IDENTIFICATION USING KNOWN COMPUTING ELEMENT AT A LOCATION,” filed Jan. 31, 2025, and which is hereby incorporated by reference in its entirety.

### BACKGROUND

Private networks frequently consist of numerous devices distributed across different locations, network segments, and underlying infrastructures. As these environments expand, it becomes increasingly difficult to determine where specific devices reside and how to reach them. Devices may authenticate through a central service yet operate behind different gateways, and their network characteristics may change as they move between physical or logical network contexts. These factors can make it challenging for one device to accurately identify another device’s network position or the appropriate route for communication.

These challenges become more pronounced in private networks that incorporate overlapping IPv4 address spaces or multiple gateways serving similar subnets. When different portions of a network reuse the same or overlapping subnets, traditional address‑based routing cannot reliably distinguish which gateway corresponds to a particular device. As a result, the task of determining the correct path to a destination device often requires complex, error‑prone configuration.

### SUMMARY

The technology disclosed herein enables network gateway identification using a computing element known to be located behind the gateway. In a particular example, a method includes, in a source computing element, receiving a destination identifier for a destination computing element and a collocated identifier for a second computing element collocated with the destination computing element in the IPv4 network. In the source computing element, the method further includes determining a gateway for connecting to the second computing element from a plurality of gateways and creating a packet with a destination IPv6 address for the destination computing element. The destination IPv6 address includes a destination IPv4 address for the destination computing element and a gateway identifier for the gateway that identifies the gateway relative to others of the plurality of gateways. The method also includes, in the source computing element, encapsulating the packet to create an encapsulated packet with a public address for the gateway corresponding to a location of the second computing element and sending the encapsulated packet to the gateway over an IPv6 network. In the gateway, the method includes extracting the packet from the encapsulated packet and sending the packet to the destination IPv4 address over the IPv4 network.

In another example, an apparatus is provided including one or more computer-readable storage media and one or more processing systems operatively coupled with the one or more computer-readable storage media. Program instructions stored on the one or more computer-readable storage media, when executed by the one or more processing systems, direct the apparatus to receive a destination identifier for a destination computing element and a collocated identifier for a second computing element collocated with the destination computing element in an IPv4 network. The program instructions further direct the apparatus to determine, from among a plurality of gateways, a gateway that services the second computing element and create a packet with a destination IPv6 address encoding a destination IPv4 address for the destination computing element and a gateway identifier for the gateway. The program instructions also direct the apparatus to encapsulate the packet for delivery to a public address of the gateway and transmit the encapsulated packet over the IPv6 network.

In a further example, a system includes a coordination service configured to maintain associations between computing elements and gateways including gateway identifiers and corresponding public network addresses and provide, responsive to requests, gateway information usable to form destination IPv6 addresses that encode IPv4 addresses and gateway identifiers. The system also includes a source computing element configured to receive a destination identifier and a collocated identifier, request gateway information from the coordination service, form a packet with a destination IPv6 address encoding a destination IPv4 address and a gateway identifier, and send an encapsulated version of the packet to a public network address of a gateway over an IPv6 network. The system further includes one or more gateways configured to extract the packet from the encapsulated packet; and forward the packet to the destination IPv4 address over an IPv4 network.

### BRIEF DESCRIPTION OF THE DRAWINGS

FIG. 1 illustrates an implementation for routing packets to an IPv4 subnet by automatically identifying a gateway to that subnet.

FIG. 2 illustrates an operation to route packets to an IPv4 subnet by automatically identifying a gateway to that subnet.

FIG. 3 illustrates an operational scenario for routing packets to an IPv4 subnet by automatically identifying a gateway to that subnet.

FIG. 4 illustrates an implementation for routing packets to an IPv4 subnet by automatically identifying a gateway to that subnet.

FIG. 5 illustrates a device-subnet mapping to route packets to an IPv4 subnet by automatically identifying a gateway to that subnet.

FIG. 6 illustrates an operation to route packets to an IPv4 subnet by automatically identifying a gateway to that subnet.

FIG. 7 illustrates a computing system for routing packets to an IPv4 subnet by automatically identifying a gateway to that subnet.

### DETAILED DESCRIPTION

Virtual Private Networks (VPNs) work by creating a logical network overlay that allows devices to communicate securely over underlying networks, such as a public or untrusted network (e.g., the Internet). The overlay is achieved through a process called encapsulation, where the data packets sent between devices are wrapped inside additional packets that include encrypted information. For instance, when a VPN endpoint device sends data through a VPN, a packet carrying the data is encrypted and then encapsulated with a new packet header that includes a public Internet Protocol (IP) address of another VPN endpoint device as the destination. This encapsulated packet is then sent over a public network to the destination VPN endpoint device.

At the destination VPN endpoint device, the outer packet header is stripped away to reveal the original encrypted packet. The original packet is then decrypted, allowing the data to be processed by the device. In some examples, the VPN endpoint device may be a VPN server operating as a gateway to the public network. In those examples, the decrypted original packet may be transmitted to a destination IP address on the public network identified in a header of the original packet. The above encryption method ensures that the data remains confidential and secure as it travels over potentially insecure networks, as only the VPN destination endpoint can decrypt and access the original information. By creating a secure tunnel through encryption and encapsulation, VPNs effectively simulate a private network over a public infrastructure, providing privacy and security for users.

A Tailnet is a VPN created using Tailscale, which leverages the WireGuard protocol to provide secure, encrypted connections between devices. This network allows devices to communicate as if they were on the same local network, regardless of their physical location. Tailscale simplifies network management by eliminating the need for complex configuration or hardware setup, making it accessible for both individuals and organizations.

Nodes in a Tailnet are authenticated using a combination of modern cryptographic techniques and identity verification. Each device that joins a Tailnet must authenticate itself via an identity provider, such as Google, Microsoft, or Okta, which ensures that only nodes associated with authorized users can connect to the Tailnet. The authentication process involves exchanging cryptographic keys to establish trust between devices, ensuring that each node can securely identify and communicate with others within the network.

Once authenticated, each device receives an IP address unique within the VPN and becomes part of the Tailnet. This IP address is used to route traffic securely within the network, and all communication is encrypted using the WireGuard protocol, although, other protocols may be used. Even if devices are on different underlying public networks, their data remains private and secure. Continuous authentication and authorization controls may also be implemented. This means devices are regularly verified and permissions can be adjusted dynamically. If a device’s status changes or if the identity provider's credentials are updated, Tailscale can enforce new access policies in real-time, maintaining the network's security and integrity.

Difficulty arises in managing communications in a network with overlapping IPv4 subnets. Traditional methods, such as VLANs and encryption, can be cumbersome to configure and manage, especially in networks with a large number of virtual and physical computing elements. This is particularly challenging when multiple gateways support overlapping IPv4 subnets, as it becomes difficult to differentiate packets destined for different gateways. The examples below use IPv6 addressing to select a correct gateway for packets to reach their intended IPv4 destination.

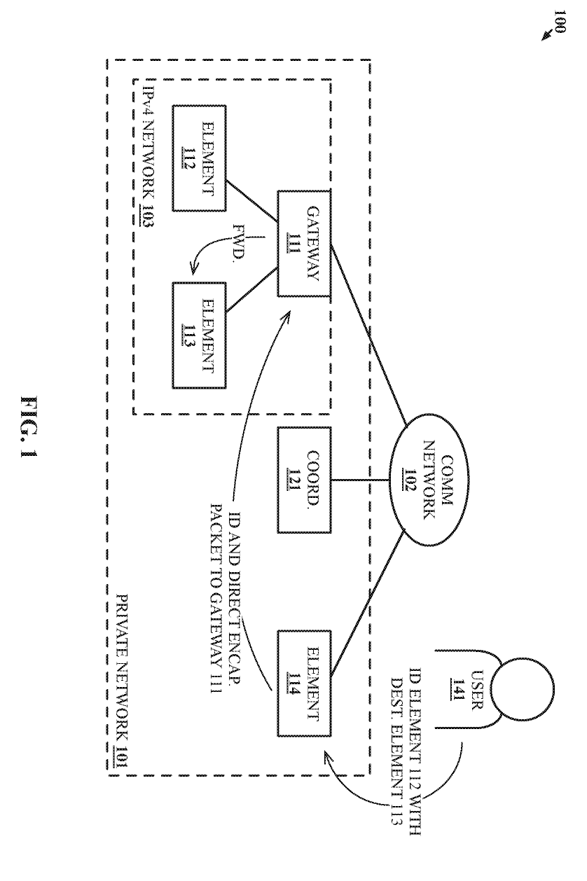

FIGS. 1 illustrates implementation 100 for routing packets to an IPv4 subnet by automatically identifying a gateway to that subnet. Implementation 100 includes private network 101, communication network 102, gateway 111, coordination service 121, and computing elements 112-114. Coordination service 121, gateway 111, and computing elements 112-114 are all part of private network 101. Private network 101 is a private network, such as a VPN/Tailnet, that uses an authentication mechanism to ensure computing devices connected to private network 101 are authorized to join private network 101. Private network 101 is an overlay network on physical networking hardware, such wired/wireless communication links, routers, switches, firewalls, computing devices, or other type of components for providing network communications between computing systems. In some examples, at least a portion of the physical networking hardware is included in, or underlies a portion of, communication network 102. IPv4 network 103 incorporates an IPv4 subnet of private network 101 that may be shared with other gateways (not shown) in private network 101. As such, an IPv4 address of computing element 112 or computing element 113 is not enough for private network 101 to determine that packets should be routed to gateway 111.

Coordination service 121 manages connections and interactions between devices within private network 101. Coordination service 121 acts as a central authority, or control plane, that facilitates the initial authentication and ongoing management computing elements connected thereto. When a device attempts to join private network 101, the device communicates with coordination service 121 to verify the device’s identity, handle key exchanges, and assign network addresses. Coordination service 121, therefore, ensures only authorized devices can connect and interact with each other over private network 101 by maintaining an up-to-date directory of valid nodes and their associated credentials.

Beyond authentication, coordination service 121 may also help with routing and maintaining connectivity within private network 101. Coordination service 121 may track the current network topology and support the dynamic updating of device information, such as IP addresses and connection states. This ensures that devices can efficiently discover and communicate with each other, even as they move between different underlying networks or change their connection statuses. By centralizing these functions, coordination service 121 simplifies network management and enhances the overall security and reliability. Coordination service 121 may be implemented in a single computing device or may be distributed across multiple devices. In some examples, at least a portion of coordination service 121 may be distributed across one or more of nodes 103-104.

Computing elements 112-114 (and gateway 111, which may be a computing element designated to be a gateway) may be laptops, desktops, network storage systems, set top boxes, printers, servers, televisions, or any other type of computing device/system – including combinations thereof. When a packet is to be sent from one element to another, the sending element addresses the packet to a destination element. In the examples below, gateway 111 is identified for the element from other gateways that may exist on private network 101. User 141 does not need to know which specific gateway leads to the desired destination element. Instead, user 141 merely needs to know the identity of another device at the location served by gateway 111. From that information, the sending element can determine gateway 111 is the proper gateway.

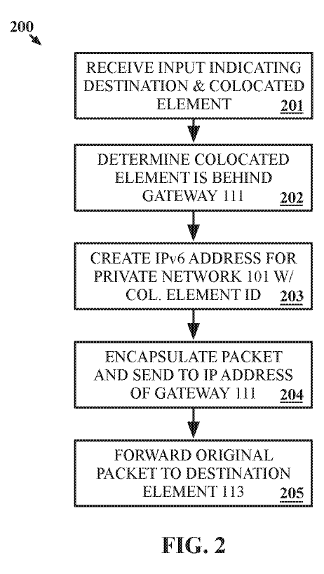

FIG. 2 illustrates operation 200 to route packets to an IPv4 subnet by automatically identifying a gateway to that subnet. In operation 200, computing element 114 receives a destination identifier for a destination computing element 113 and a collocated identifier for another computing element 112 that user 141 knows is collocated with computing element 113 in IPv4 network 103 (201). User 141 may be presented with a list of devices that they can select as a destination. For example, if user 141 wants to access a printer, user 141 does not need to identify the location of the printer because user 141 may not necessarily know the name of the location to be able to select a printer at that location. However, user 141 may know that a video streaming box is connected to private network 101 at the desired location. If that’s the case, user 141 may indicate to computing element 114 (e.g., via a software client for communicating over private network 101) that they want packets sent to a printer (e.g., computing element 113) collocated with the video streaming box (e.g., computing element 112). The identifiers may be IPv4 addresses assigned to computing element 112 and computing element 113. Although, even with those addresses, since the IPv4 subnet could span multiple gateways, simply directing packets to the IPv4 addresses will not necessarily cause the addresses to be routed to the correct gateway (i.e., gateway 111).

In response to receiving the input from user 141, computing element 114 determines which gateway serves computing element 112 and computing element 113 (step 202). Computing element 114 may query the control plane to ask which gateway of many gateways on private network 101 services computing element 112 and computing element 113. Alternatively, computing element 114 may maintain a routing information itself indicating that gateway 111 is the gateway servicing computing element 112 and computing element 113. Other mechanisms for determining a corresponding gateway may also be used.

Computing element 114 creates a packet with a destination IPv6 address for the destination computing element even though computing element 113 is on IPv4 network 103 (step 203). An IPv6 address is 128 bits long while an IPv4 header is only 32 bits long. This enables the destination IPv6 address to include a destination IPv4 address for the destination computing element in IPv4 network 103 and a gateway identifier for gateway 111. The destination IPv4 address may be determined by computing element 114 determining which computing element matching the characteristics of the destination identified by the destination identifier. Continuing the above example, the identifier may indicate user 141 desires a printer (or a specific type/model of printer if multiple printers may be at the location). Then computing element 114 determines an IPv4 address of computing element 113, a printer, collocated with computing element 112, the video streaming box. The identifier for gateway 111 may be any string of bits in the IPv6 address that is different than strings of bits representing other gateways to which the packets may be directed. In some examples, the identifier for gateway 111 may be an address for gateway 111.

Computing element 114 encapsulates the packet to create an encapsulated packet (step 204). A component of computing element 114 tasked with encapsulating packets reads the IPv6 address and recognizes the identifier for gateway 111. A public IP address for gateway 111 over communication network 102 is identified (e.g., by querying coordination service 121 or referencing a data structure of gateway identifiers and corresponding addresses). The encapsulated packet is addressed to the IP address of gateway 111 and sent to gateway 111 over communication network 102.

When gateway 111 receives the encapsulated packet, gateway 111 extracts the packet from the encapsulated packet and forwards the original packet to computing element 113 at the IPv4 address of computing element 113 (step 205). When gateway 111 removes the encapsulation, gateway 111 also replaces the IPv6 packet with the IPv4 address of computing element 113 that is a component of the IPv6 packet. Thus, the packet ends up at the destination intended by user 141 without user 141 having to identify gateway 111 explicitly.

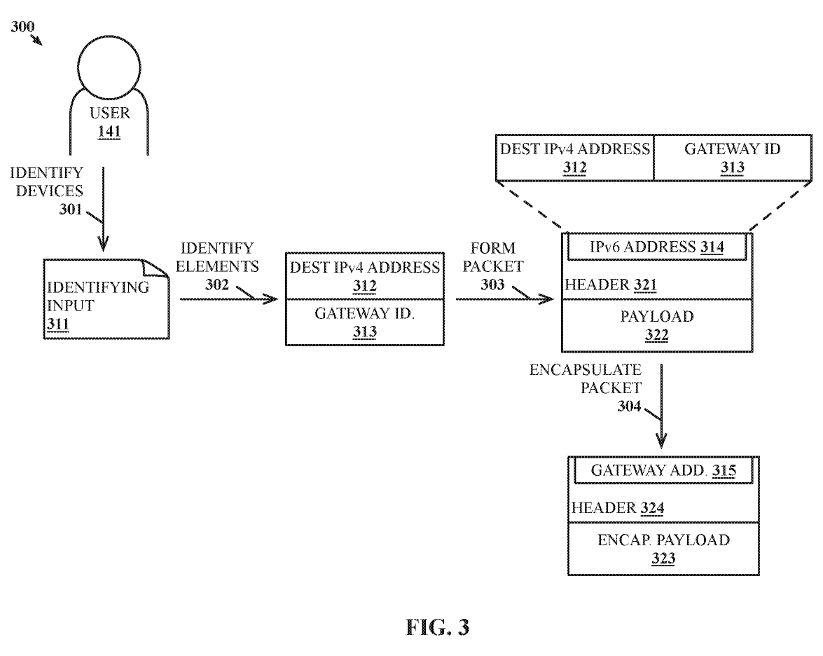

FIG. 3 illustrates operational scenario 300 for routing packets to an IPv4 subnet by automatically identifying a gateway to that subnet. Operational scenario 300 is an example of how a packet may be encapsulated and sent to gateway 111. In operational scenario 300, user 141 provides input 311 into computing element 114 identifying the device to which user 141 wants computing element 114 to connect and computing element 112 that user 141 knows is at the same location as computing element 112 (step 301). From input 311, computing element 114 determines computing element 113 is the desired destination for packet communications and identifies an IPv4 address of computing element 113 (step 302). Computing element 114 likewise determines gateway 111 services computing element 112 and determines gateway identifier 313 corresponds to gateway 111. Destination IPv4 address 312 and gateway identifier 313 are used as components in IPv6 address 314 for a packet (and any subsequent packets directed to computing element 113) (step 303). IPv6 address 314 is an IPv6 address in that it conforms to formatting requirements of IPv6 addresses in packet header 321 but is not an actual address assigned to a device. Payload 322 of the packet includes information to be sent from computing element 114 to computing element 113. Computing element 114 then encapsulates the packet into encapsulated payload 323 of an encapsulated packet directed towards gateway address 315 (step 304). Encapsulating the packet may include encrypting the packet using a public key assigned to computing element 113 by coordination service 121 such that the packet can only be decrypted by a private key at computing element 113. Packet header 324 is the header of the encapsulated packet and includes gateway address 315 for routing over communication network 102. When received by gateway 111, encapsulated payload 323 is unencapsulated to recover payload 322 and IPv6 address 314 is replaced by destination IPv4 address 312 in packet header 321. This directs the packet to computing element 113 over IPv4 network 103.

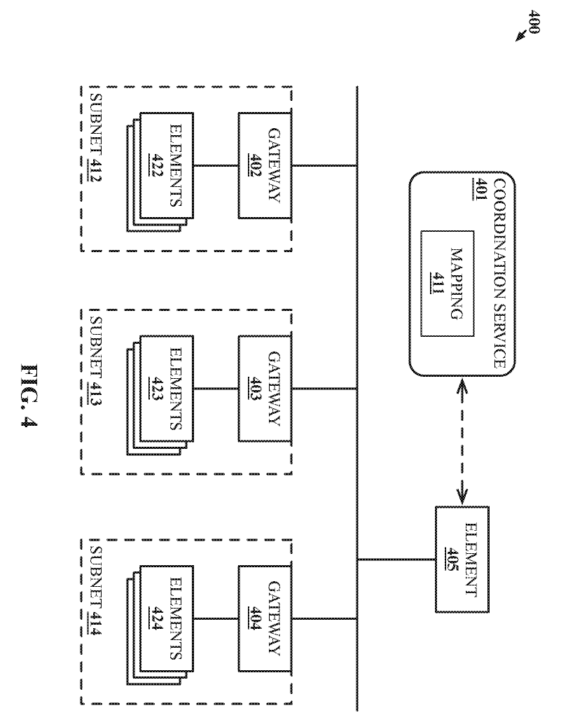

FIG. 4 illustrates implementation 400 for routing packets to an IPv4 subnet by automatically identifying a gateway to that subnet. Implementation 400 includes coordination service 401, which operates as a control plane of a private network that spans subnet 412, subnet 413, and subnet 414. The private network may be implemented as an overlay network such as a virtual private network that authenticates participating computing elements and gateways and coordinates their communications over one or more underlying public or private networks. Coordination service 401 may be centralized, distributed, or hierarchically partitioned across regions or sites, and may maintain current associations between computing elements, subnets, and gateways together with addressing and policy information used to route traffic within the private network.

Computing element 405 is shown outside of subnets 412-414 for clarity, although in practice computing element 405 may be located within any site or subnet connected to the private network or may be remote and connected through another gateway. Computing element 405 may be, by way of example, a laptop, desktop, server, embedded controller, or mobile device executing a private‑network client that performs the operations described herein.

Gateway 402 enables access to computing elements 422 in subnet 412, gateway 403 enables access to computing elements 423 in subnet 413, and gateway 404 enables access to computing elements 424 in subnet 414. Each gateway represents a termination point of the private network overlay and an ingress/egress point to a corresponding IPv4 subnet. Gateways may be software agents, virtual appliances, or physical routers/firewalls, and may advertise availability, health, and the subnets they service to coordination service 401. In some examples, multiple gateways may be implemented for a given subnet to provide high availability, failover, or load distribution. Multiple gateways that service the same subnet may be assigned a common gateway identifier or site identifier and treated as a high‑availability set, with one gateway selected as active and eligible to receive encapsulated packets while one or more peers remain on standby.

In various examples, subnets 412-414 may use overlapping IPv4 address ranges so that the same IPv4 address can appear in more than one subnet. For example, each customer site may use a default private address range such as 10.1.1.0/24 for local devices. When IPv4 address ranges overlap across different sites, the private network uses a disambiguation mechanism that combines the destination IPv4 address with a gateway identifier (e.g., a site identifier) to construct a destination IPv6 address that uniquely represents the intended destination device and the gateway through which that device is reachable. In these examples, computing element 405 can send a packet to a unique destination IPv6 address even when the underlying IPv4 address is not unique across the private network.

Coordination service 401 may maintain or derive information usable by computing element 405 to construct destination IPv6 addresses and select an appropriate gateway. In one example, coordination service 401 maintains, for each site, a site identifier chosen from a range of integer values (e.g., 0–65535) that serves as or forms part of a gateway identifier. In another example, coordination service 401 reserves an IPv6 prefix for private‑network translation and specifies a formatting scheme for destination IPv6 addresses such that distinct fields store (i) the reserved prefix, (ii) a translator‑identifier field that stores the gateway identifier, and (iii) an IPv4‑address field that stores the destination IPv4 address. The translator‑identifier field may be 32 bits in some examples, with its lower 16 bits serving as a site identifier. Computing element 405, upon learning the site identifier for the correct gateway, can populate the translator‑identifier field and the IPv4‑address field to yield an unambiguous destination IPv6 address for the destination computing element.

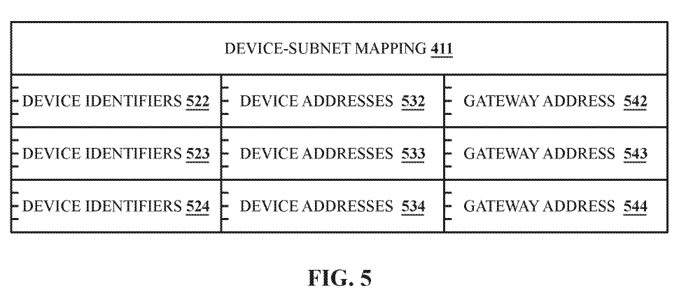

FIG. 5 illustrates device‑subnet mapping 411 used to route packets to an IPv4 subnet by automatically identifying a gateway to that subnet. Device‑subnet mapping 411 may be maintained by coordination service 401 and may be populated from device registration events, gateway advertisements, administrative configuration, or discovery processes. Device‑subnet mapping 411 lists device identifiers 522 for respective computing elements 422, device addresses 532 for computing elements 422, and gateway address 542 for gateway 402 through which computing elements 422 can be reached. A device identifier can be any identifier that uniquely identifies a computing element within the private network, such as a node identifier assigned by the private network, a cryptographic public key fingerprint, a hostname, a hardware identifier, or a combination thereof. Device addresses 532 represent the IPv4 addresses assigned to computing elements 422 within subnet 412.

Device‑subnet mapping 411 further lists device identifiers 523 for computing elements 423, device addresses 533 for computing elements 423, and gateway address 543 for gateway 403 through which computing elements 423 can be reached. Device‑subnet mapping 411 also lists device identifiers 524 for computing elements 424, device addresses 534 for computing elements 424, and gateway address 544 for gateway 404 through which computing elements 424 can be reached. As noted above, device addresses 532-534 may include identical IPv4 addresses across different subnets, so that the gateway address associated with the device identifier is used to disambiguate overlapping IPv4 addresses.

In some examples, device‑subnet mapping 411 additionally records a gateway identifier or site identifier for each subnet, and may record the deterministic hostnames that the private network assigns to devices in those subnets. A deterministic hostname may be generated from a device’s IPv4 address and a site identifier using a predefined, reversible encoding. For instance, an IPv4 address of 10.1.1.16 in a site having a site identifier of 7 may be assigned a deterministic name that encodes the octets of the IPv4 address and the site identifier. A private name service or the coordination service can then resolve that deterministic hostname to the destination IPv6 address that encodes both the IPv4 address (10.1.1.16) and the site identifier (7). In other examples, device‑subnet mapping 411 includes a reserved IPv6 prefix value for private‑network translation and specifies how the translator‑identifier field and the IPv4‑address field are populated to form the destination IPv6 address. The mapping may also indicate a set of gateways that advertise the same gateway identifier for high availability and which of those gateways is currently active.

Coordination service 401 can reference device‑subnet mapping 411 to determine whether the identifier of a collocated device is present in device identifiers 522, device identifiers 523, or device identifiers 524. If, for example, the identifier is in device identifiers 523, coordination service 401 recognizes that the collocated device resides within subnet 413 and that gateway address 543 should be used for communications related to that subnet. Coordination service 401 may also return the gateway identifier or site identifier associated with subnet 413, a public network address of gateway 403 for encapsulated delivery, and optionally the IPv4 address of a destination device selected for the request. In some cases, coordination service 401 may respond with both an active gateway and a standby gateway for the same gateway identifier so that a source can fail over quickly if conditions change.

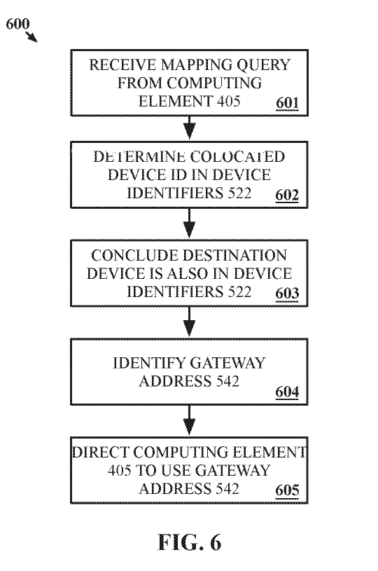

FIG. 6 illustrates operation 600 to route packets to an IPv4 subnet by automatically identifying a gateway to that subnet. In operation 600, computing element 405 is preparing to send packets to a destination computing element. A user of computing element 405 may not know where the desired destination device is located (e.g., which of subnets 412-414) but may know the identity of another device collocated with the destination device on the same subnet. For instance, the user may want to send a print job to a particular printer but only knows that the printer is collocated with a media player that the user can identify. In other examples, the user may specify a device type (e.g., “printer,” “camera,” or “controller”) as the destination identifier rather than a specific device, in which case computing element 405 or coordination service 401 selects an IPv4 address of a device of that type that is collocated with the identified device.

In operation 600, coordination service 401 receives a mapping query from computing element 405 requesting a gateway to which packets should be sent (step 601). The mapping query identifies a collocated device and an intended destination. The intended destination may be specified in various ways, including by a device type, by a hostname, by a deterministic hostname, by a logical resource label, or by an IPv4 address that may overlap between subnets. The query may also include policy context, such as a user identity or application tag, which the coordination service can use to enforce access controls when returning routing information.

In this example, coordination service 401 determines that the identifier of the collocated device is included in device identifiers 522 and is therefore one of computing elements 422 (step 602). Based on that determination, coordination service 401 concludes that the intended destination device is also one of computing elements 422 collocated within the same subnet 412 (step 603). This inference allows the system to determine the correct subnet and gateway without requiring the user to know site names, subnet identifiers, or the public address of a gateway.

Coordination service 401 determines that gateway address 542 should be used to direct packets from computing element 405 (step 604). Coordination service 401 may also determine a gateway identifier or site identifier for subnet 412, the IPv4 address of the destination device (when the destination is specified by device type or hostname), and a public network address of gateway 402 to which encapsulated packets should be sent. Coordination service 401 may identify which gateway among multiple gateways sharing the same gateway identifier is currently active, for example by applying health checks, load information, or predefined priority rules to the members of a high‑availability set. Coordination service 401 then directs computing element 405 to use gateway address 542 for the packets and provides sufficient information for computing element 405 to generate a destination IPv6 address and encapsulate the packets for transport to gateway 402 (step 605).

In one example, computing element 405 constructs a packet whose destination IPv6 address encodes the destination IPv4 address and the gateway identifier in distinct bit fields according to the private network’s addressing scheme. The addressing scheme may use a prefix reserved for private‑network translation, a translator‑identifier field that stores the gateway identifier (e.g., with its lower 16 bits serving as a site identifier), and an IPv4‑address field that stores the destination IPv4 address. In another example, computing element 405 may generate or resolve a deterministic hostname for the destination computing element based on the destination IPv4 address and site identifier. The deterministic hostname can then be resolved within the private network to the corresponding destination IPv6 address. These alternatives allow computing element 405 either to synthesize the destination IPv6 address directly from values returned by coordination service 401 or to obtain the destination IPv6 address through name resolution.

In some implementations, computing element 405 encrypts the packet using a public key associated with the destination computing element prior to encapsulation so that only the destination computing element can decrypt the payload upon receipt. The encrypted packet is then encapsulated with an outer header addressed to the public network address of gateway 402. Encapsulation may be performed by a tunneling protocol or another overlay mechanism used by the private network. Computing element 405 transmits the encapsulated packet over an IPv6 network to gateway 402. Upon receipt, gateway 402 extracts the inner packet from the encapsulated packet and replaces the destination IPv6 address in the packet header with the destination IPv4 address prior to forwarding the packet over the IPv4 subnet toward the destination device. In some examples, gateway 402 performs network address translation or routing operations as needed to deliver the packet to the destination computing element.

To improve performance and reduce coordination‑service load, computing element 405 may cache a mapping between the collocated device identifier and the gateway identifier returned by coordination service 401. The cache may include a time‑to‑live, version information, or a subscription to change notifications so that computing element 405 can update or invalidate cached entries when a site fails over to a different active gateway, when devices move between subnets, or when access policies change. Similarly, computing element 405 may cache resolved deterministic hostnames and their corresponding destination IPv6 addresses, subject to time‑limited validity.

In high‑availability scenarios, multiple gateways may advertise the same gateway identifier for the same subnet. Coordination service 401 may select an active gateway within the high‑availability set to receive encapsulated packets and may change that selection over time in response to failures, maintenance, or policy. Computing element 405 may select the public address of the currently active gateway when transmitting encapsulated packets such that traffic continues to reach the intended site without requiring changes to destination IPv6 addresses. If a failover occurs, coordination service 401 may notify computing element 405, or computing element 405 may retry with a different public address associated with the same gateway identifier.

Name resolution within the private network may map a deterministic hostname derived from a device’s IPv4 address and a site identifier to the corresponding destination IPv6 address. This allows applications on computing element 405 that rely on hostnames to connect to devices in overlapping IPv4 subnets without ambiguity. In some examples, computing element 405 first resolves a deterministic hostname to obtain the destination IPv6 address and then encapsulates packets toward the active gateway’s public address, as discussed above. In other examples, computing element 405 queries coordination service 401 for the deterministically generated hostname corresponding to a given IPv4 address and site identifier, thereby enabling either address‑based or name‑based workflows.

Although FIGS. 4-6 emphasize the interaction with coordination service 401, the same techniques may be implemented with different divisions of responsibility. For example, computing element 405 may determine a gateway identifier locally from a previously cached association and may construct the destination IPv6 address without contacting coordination service 401 for each connection. In another example, gateways may advertise their identifiers and the subnets they service, and computing element 405 may select a gateway based on the collocated device information and local routing logic. These alternatives remain compatible with the addressing scheme that encodes the destination IPv4 address and gateway identifier in the destination IPv6 address and with the encapsulate‑extract‑forward pattern described above.

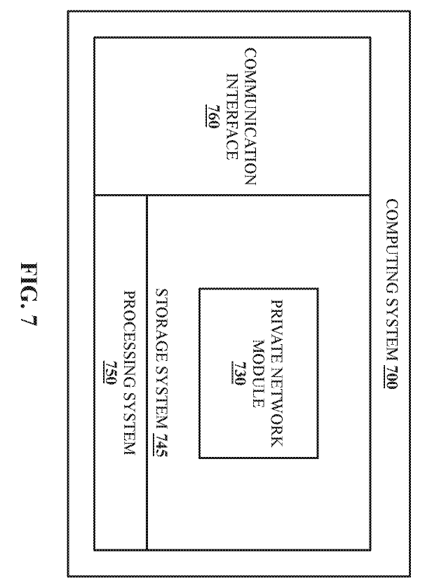

FIG. 7 illustrates computing system 700 for routing packets to an IPv4 subnet by automatically identifying a gateway to that subnet. Computing system 700 is representative of any computing system or systems with which the various operational architectures, processes, scenarios, and sequences disclosed herein can be implemented. Computing system 700 is an example architecture for coordination service 121, coordination service 401, computing elements 112-117, computing elements 405, 422-424, gateway 111, and gateways 402-404, although other examples may exist. Computing system 700 includes storage system 745, processing system 750, and communication interface 760. Processing system 750 is operatively linked to communication interface 760 and storage system 745. Communication interface 760 may be communicatively linked to storage system 745 in some implementations. Computing system 700 may further include other components such as a battery and enclosure that are not shown for clarity.

Communication interface 760 comprises components that communicate over communication links, such as network cards, ports, radio frequency (RF), processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format – including combinations thereof. Communication interface 760 may be configured to communicate with other computing systems via one or more networks.

Processing system 750 comprises microprocessor and other circuitry that retrieves and executes operating software from storage system 745. Storage system 745 may include volatile and nonvolatile, removable, and non-removable media implemented in any method or technology for storage of information, such as computer readable instructions, data structures, program modules, or other data. Storage system 745 may be implemented as a single storage device but may also be implemented across multiple storage devices or sub-systems. Storage system 745 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretations would storage media of storage system 745, or any other computer-readable storage medium herein, be considered a transitory form of signal transmission (often referred to as "signals per se"), such as a propagating electrical or electromagnetic signal or carrier wave.

Processing system 750 is typically mounted on a circuit board that may also hold the storage system. The operating software of storage system 745 comprises computer programs, firmware, or some other form of machine-readable program instructions. The operating software of storage system 745 comprises private network module 730. The operating software on storage system 745 may further include an operating system, utilities, drivers, network interfaces, applications, or some other type of software. When read and executed by processing system 750 the operating software on storage system 745 directs computing system 700 to perform packet routing as described herein. Private network module 730 may execute natively on processing system 750 or the operating software may include virtualization software, such as a hypervisor, to virtualize computing hardware on which private network module 730 executes.

In at least one example, private network module 730 executes on processing system 750 and directs processing system 750 to receive a destination identifier for a destination computing element and a collocated identifier for a second computing element collocated with the destination computing element in the IPv4 network, determine a gateway for connecting to the second computing element from a plurality of gateways, and create a packet with a destination IPv6 address for the destination computing element. The destination IPv6 address includes a destination IPv4 address for the destination computing element and a gateway identifier for the gateway that identifies the gateway relative to others of the plurality of gateways. Private network module 730 further directs processing system 750 to encapsulate the packet to create an encapsulated packet with a public address for the gateway corresponding to a location of the second computing element and sends the encapsulated packet to the gateway over an IPv6 network. The gateway extracts the packet from the encapsulated packet and sends the packet to the destination IPv4 address over the IPv4 network.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for connecting to an Internet Protocol (IP) version 4 (IPv4) network over an IP version 6 (IPv6) network, the method comprising:
in a source computing element:
receiving a destination identifier for a destination computing element and a collocated identifier for a second computing element collocated with the destination computing element in the IPv4 network;
determining a gateway for connecting to the second computing element from a plurality of gateways;
creating a packet with a destination IPv6 address for the destination computing element, wherein the destination IPv6 address includes a destination IPv4 address for the destination computing element and a gateway identifier for the gateway that identifies the gateway relative to others of the plurality of gateways;
encapsulating the packet to create an encapsulated packet with a public address for the gateway corresponding to a location of the second computing element; and
sending the encapsulated packet to the gateway over an IPv6 network; and
in the gateway:
extracting the packet from the encapsulated packet; and
sending the packet to the destination IPv4 address over the IPv4 network.

2. The method of claim 1, wherein determining the gateway comprises:
querying a coordination service for the gateway using the collocated identifier, wherein the coordination service maintains associations between computing elements and gateways in a private network.

3. The method of claim 1, wherein the destination IPv6 address conforms to an IPv6 formatting scheme that encodes the destination IPv4 address and the gateway identifier in distinct bit fields.

4. The method of claim 3, wherein the gateway identifier comprises a site identifier selected from a range of integer values.

5. The method of claim 4, wherein the site identifier is a 16-bit portion of the destination IPv6 address.

6. The method of claim 1, wherein the destination identifier indicates a device type, and selecting the destination IPv4 address comprises:
selecting an IPv4 address of a device of the device type collocated with the second computing element.

7. The method of claim 1, wherein encapsulating the packet comprises:
encrypting the packet using a public key associated with the destination computing element prior to encapsulation.

8. The method of claim 1, comprising:
caching a mapping between the collocated identifier and the gateway identifier for subsequent packets directed to the destination computing element.

9. The method of claim 1, comprising:
in the gateway, replacing the destination IPv6 address in a packet header of the packet with the destination IPv4 address prior to forwarding over the IPv4 network.

10. The method of claim 1, comprising:
generating, for the destination computing element, a deterministic hostname based on the destination IPv4 address and a site identifier for resolution within a private network between the source computing element and the gateway.

11. An apparatus to transmit traffic to an IPv4 destination through a selected gateway over an IPv6 network, the apparatus comprising:
one or more computer-readable storage media;
one or more processing systems operatively coupled with the one or more computer-readable storage media; and
program instructions stored on the one or more computer-readable storage media that, when executed by the one or more processing systems, direct the apparatus to:
receive a destination identifier for a destination computing element and a collocated identifier for a second computing element collocated with the destination computing element in an IPv4 network;
determine, from among a plurality of gateways, a gateway that services the second computing element;
create a packet with a destination IPv6 address encoding a destination IPv4 address for the destination computing element and a gateway identifier for the gateway;
encapsulate the packet for delivery to a public address of the gateway; and
transmit the encapsulated packet over the IPv6 network.

12. The apparatus of claim 11, wherein the program instructions direct the apparatus to:
use a prefix reserved for private-network translation in the destination IPv6 address; and
include the gateway identifier in a translator-identifier field of the destination IPv6 address.

13. The apparatus of claim 11, wherein the program instructions direct the apparatus to:
resolve, from a coordination service for a private network connecting the destination computing element and the apparatus, the public address of the gateway corresponding to the gateway identifier.

14. The apparatus of claim 11, wherein the program instructions direct the apparatus to:
generate a deterministic hostname that encodes at least the destination IPv4 address and the gateway identifier; and
resolve the destination IPv6 address from the deterministic hostname.

15. The apparatus of claim 11, wherein the program instructions direct the apparatus to:
identify, among multiple gateways sharing the gateway identifier, the gateway as being an active gateway of a high‑availability set;
select the public address of the active gateway for packet delivery; and
transmit the encapsulated packet to the public address of the active gateway for forwarding toward the destination computing element.

16. A system for routing traffic to an IPv4 destination across an IPv6 transport in a private network, the system comprising:
a coordination service configured to:
maintain associations between computing elements and gateways including gateway identifiers and corresponding public network addresses; and
provide, responsive to requests, gateway information usable to form destination IPv6 addresses that encode IPv4 addresses and gateway identifiers;
a source computing element configured to:
receive a destination identifier and a collocated identifier;
request gateway information from the coordination service;
form a packet with a destination IPv6 address encoding a destination IPv4 address and a gateway identifier; and
send an encapsulated version of the packet to a public network address of a gateway over an IPv6 network; and
one or more gateways configured to:
extract the packet from the encapsulated packet; and forward the packet to the destination IPv4 address over an IPv4 network.

17. The system of claim 16, wherein gateways of the one or more gateways advertising a same gateway identifier constitute a high-availability set and wherein the coordination service is configured to:
select an active gateway within the high-availability set to receive encapsulated packets.

18. The system of claim 16, wherein the destination IPv6 address conforms to an addressing scheme using a reserved IPv6 prefix, a translator-identifier field that stores the gateway identifier, and an IPv4-address field that stores the destination IPv4 address.

19. The system of claim 16, wherein the destination IPv4 address is present in a plurality of overlapping IPv4 subnets advertised by different gateways, and the gateway identifier in the destination IPv6 address specifies to which of the overlapping IPv4 subnets a destination computing element corresponding to the destination IPv4 address belongs.

20. The system of claim 16, wherein name resolution within the private network maps a hostname derived from an IPv4 address and a gateway identifier to the destination IPv6 address.
